(19) United States
(12) Patent Application Publication
(10) Pub. No.: US 2017/0201518 A1
(43) Pub. Date: Jul. 13, 2017

(54) METHOD AND SYSTEM FOR REAL-TIME AUTHENTICATION OF USER ACCESS TO A RESOURCE

(71) Applicant: Lastwall Networks Inc., Vancouver (CA)

(72) Inventors: Karl Holmqvist, Vancouver (CA); Ian Rutherford, Vancouver (CA); Thomas Varghese, Los Altos Hill, CA (US); Andrew Rohan Mckenzie, Vancouver (CA)

(21) Appl. No.: 15/508,887

(22) PCT Filed: Sep. 4, 2015
(86) PCT No.: PCT/CA2015/050857

§ 371 Date: Mar. 3, 2017

Related U.S. Application Data
(60) Provisional application No. 62/046,369, filed on Sep. 5, 2014.

(51) Int. Cl. H04L 29/06; G06F 21/34; G06F 21/40; H04L 9/32

(52) U.S. Cl. CPC H04L 63/0884; H04L 63/10; H04L 63/12; H04L 9/321; G06F 21/34; G06F 21/40

(57) ABSTRACT

A method and system for authenticating user access to a resource is disclosed having the steps of receiving an access request from a user to access a resource, sending an authentication request to an authenticator, receiving an authentication response from the authenticator, providing access to the resource if the authentication response is validated by each authenticator; and denying access to the resource if the authentication response is not validated by the authenticator.

### FIELD

The present invention relates to online security. More specifically, the present invention relates to methods and systems for providing real time authentication of a user who is attempting to access a resource.

### BACKGROUND

With the proliferation of online access to various internet and network based resources, users are remotely accessing a wide variety of services through their desktop and laptop computers, mobile smartphones, tablet devices, wearable devices and many other network-based devices. As users increasingly use the internet to provide sensitive personal information and gain access to valuable network-based resources, security becomes paramount.

One example of a typical prior art solution for securely accessing a network-based resource involves a user generated (or alternatively, randomly generated) password that is stored by the resource provider and requested when the user attempts to gain access to the resource

Such prior art systems have a host of drawbacks. First, passwords are not particularly secure forms of identification. Passwords can be stolen or hacked by sophisticated computer programs. Secondly, secure passwords that consist of a large number of random alphanumeric characters are difficult to remember, and are often forgotten. Therefore, an important part of these systems is having an easy way for users to reset their passwords. Such password reset functions often require a user to securely access a website and/or phone an IT department or service operator to initiate the reset process. This often requires the user to provide additional information to identify themselves.

Typically when attempting to access a secure network resource, reset a password, remotely delete data, or perform any other sensitive operation, users are prompted to provide at least one piece of information. In some applications, additional pieces of information are obtained from the user in order to augment a successfully provided password, in order to provide an additional layer of security when attempting to access the resource.

In some instances, this information can be something that a user knows (like an answer to a previously selected security question, such as a birthdate or a pet's name). In these cases, the resource provider can compare the user provided information with a previously stored piece of information. If the two match, the user is provided access to the resource.

In other instances, a user is prompted to provide a piece of information that the user has. This could be, for example, algorithmic, a USB, sequence or time based token (for example, RSA SecureID tokens or Yubikeys), a traditional key, a RFID key, or any other type of asset that a user can physically possess. In an analogous manner to that described above, if the provided information contained in the asset matches the information expected by the resource provider, the user is provided access to the resource.

In other instances, a user is prompted to provide a piece of information that the user is, or in other words, an inherent quality of the user. This could be, for example, a retinal scan, fingerprint scan, or DNA sample that is compared to a corresponding piece of information that was previously provided to the resource provider. In an analogous manner as to that described above, if the provided information matches the information expected by the resource provider, the user is provided access to the resource.

In all the above scenarios, an additional layer of security is provided based on information that is known, inherent or possessed. In all cases, information of this type can be obtained by third parties that wish to gain unauthorized access to a resource. Possession factors can be stolen or replicated. Biometric and most knowledge factors are static pieces of data which do not change, which poses a systematic risk. If a users' biometric or knowledge factor is stolen, the factor becomes permanently compromised, preventing a user from ever using it again. In addition, knowledge factors can increasingly be found in publicly accessible databases. For example, a user's date of birth, familial relations, street addresses and schooling information (commonly used knowledge factor questions) can be found on public social media profiles

This fundamentally makes these commonly used factors inherently insecure. Therefore, it is an object of the present invention to provide real-time authentication of user access to a resource that cannot easily be randomly guessed, hacked or otherwise circumvented by a malicious outside party.

Further, known authentication methods often involve exchange of information that is of no particular value or interest to the user. In the present invention, it is contemplated that authentication can be completed using information that is of particular value or interest to the user, thereby increasing the user's recollection and retention of the information used in the authentication process.

### BRIEF SUMMARY

The present invention provides a system and method for providing real-time authentication of user access to a resource that requires input from an authenticator, and accordingly is resistant to subversion by a malicious outside party.

In at least one embodiment, the present invention provides a method for authenticating user access to a resource, the method having the steps of receiving an access request from a user to access a resource, sending at least one authentication request to at least one authenticator, receiving an authentication response from the at least one authenticator, providing access to the resource if the authentication response is validated by at least one of the at least one authenticator, and denying access to the resource if the authentication response is not validated by at least one of the at least one authenticator.

In another embodiment, the present invention provides a method for authenticating user access to a resource, the method having the steps of receiving an access request from a user to access a resource, obtaining an identification factor from the user, receiving the identification factor from the user, comparing the identification factor against a database of predetermined identification factors associated with the user to determine if the identification factor is correct, denying access to the resource if the identification factor is not correct, sending at least one authentication request to at least one authenticator if the identification factor is correct, the authentication request including a real time representation of the user, receiving an authentication response from the at least one authenticator, providing access to the resource if the authentication response is validated by at least one of the at least one authenticator, and denying access to the resource if the authentication response is not validated by at least one of the at least one authenticator.

In another embodiment, the present invention provides a system for authenticating user access to a resource having communication means for receiving an access request from a user to access a resource, communication means for sending at least one authentication request to at least one authenticator, communication means receiving an authentication response from the at least one authenticator, communication means for providing access to the resource if the authentication response is validated by the at least one of the at least one authenticator, and communication means for denying access to the resource if the authentication response is not validated by at least one of the at least one authenticator.

In another embodiment, the present invention provides system for authenticating user access to a resource having communication means for receiving an access request from a user to access a resource, communication means for obtaining an identification factor from the user, communication means for receiving the identification factor from the user, communication and comparison means for comparing the identification factor against a database of predetermined identification factors associated with the user to determine if the identification factor is correct, communication means for denying access to the resource if the identification factor is not correct, communication means for sending at least one authentication request to at least one authenticator if the identification factor is correct, the authentication request including a real time representation of the user, communication means for receiving an authentication response from the at least one authenticator, communication means for providing access to the resource if the authentication response is validated by at least one of the at least one predetermined third party, and communication means for denying access to the resource if the authentication response is not validated by at least one of the at least one predetermined third party.

### DESCRIPTION OF THE FIGURES

The present invention will be better understood in connection with the following figures, in which:

FIG. 1 is a flowchart illustrating at least one embodiment of the present invention wherein a single user is authenticated by a single authenticator in accordance with the present invention;

FIG. 2 is a flowchart illustrating of another embodiment of the present invention wherein a single user is authenticated by a single authenticator after providing an identification factor in accordance with the present invention;

FIG. 3 is a flowchart illustrating of another embodiment of the present invention wherein a single user is authenticated by multiple authenticators in a parallel manner in accordance with the present invention;

FIG. 4 is a flowchart illustrating of another embodiment of the present invention wherein a single user is authenticated by multiple authenticators in a parallel manner after providing an identification factor in accordance with the present invention;

FIG. 5 is a flowchart illustrating of another embodiment of the present invention wherein a single user is authenticated by multiple authenticators in a serial manner in accordance with the present invention;

FIG. 6 is a flowchart illustrating of another embodiment of the present invention wherein a single user is authenticated by multiple authenticators in a serial manner after providing an identification factor in accordance with the present invention; and

FIG. 7 is a flowchart illustrating at least one embodiment of the present invention wherein the user is the authenticator and the authentication request includes an advertisement and the authentication response includes the user's identification of the advertisement in accordance with the present invention.

### DETAILED DESCRIPTION OF THE EMBODIMENTS

The present invention provides a system and method for authenticating user access to a resource wherein the method has the steps of receiving an access request from a user to access a resource, sending an authentication request to an authenticator; receiving an authentication response from the authenticator, providing access to the resource if the authentication response is validated by the authenticator, and denying access to the resource if the authentication response is not validated by the authenticator.

It is contemplated at all communications referred to herein can be conducted through a single, central server or alternatively can be originated from a variety of remote servers in order to make the system more inaccessible to any malicious third parties. Further, it is contemplated that in embodiments where communications originate from a variety of remote servers the servers can regularly and randomly change addressing information to disguise the source of the server where the communication originates from.

In at least one embodiment, it is contemplated that a resource can include, but is not limited to, network resources such as digital data, electronic files, documents, databases, pictures, social network profiles, music, websites, online bank services and accounts, email services accounts, computer systems, user accounts, software applications, digital storage, virtual private networks, networking equipment, load balancers, routers, switches, storage area networks, network attached storage, KVM (keyboard, video and mouse) access, servers, modems, wireless repeaters, remote desktops, virtual machines, hypervisors, device profiles, identity management platform access and identity management platform profiles, among any other type of network resources that will readily be understood by the skilled person.

In at least one embodiment, it is contemplated that the resource is a network resource that must be accessed remotely through a network by way of known electronic communication means and methods. In some embodiments, it is contemplated that the resource can be accessed through a device connected to a network. In some embodiments, it is contemplated that the resource is accessed through a device by way of thick client applications, thin client applications, firmware, smart client applications and web based applications (i.e.: websites), among any other arrangements that will be readily understood by the skilled person.

In at least one embodiment, it is contemplated that an access request could be, but is not limited to, a password reset request or a standard access request, among any other type of access request to a resource that will be readily understood by the skilled person.

In at least one embodiment, it is contemplated that an authentication request could be, but is not limited to, an email request, an SMS request, an application-based request, a web-based request, a phone call, a video call, a smartphone application notification, a software request, a software notification, an instant messaging notification, an instant messaging message, a presence system notification, a presence system alert, a presence system call, a presence system message, a VoIP message, a VoIP call, a VoIP video call, a social network message, a social network alert and a social network notification, among any other suitable type of requests that will readily be understood by the skilled person.

In at least one embodiment, it is contemplated that the authentication request includes a real time representation of the user that can be a live video of the user. In such embodiments, the video could include audio or it could not include audio. It is further contemplated that the real time representation of the user is provided as a link or element within the authentication request and in other embodiments the real time representation of the user is embedded directly within the authentication request, among other arrangements that will be readily understood by the skilled person.

In at least one embodiment, the authentication request includes an advertisement that can be a video advertisement, print advertisement, an interactive advertisement, a targeted advertisement, a communication advertisement and an audio advertisement, among other types of advertisements that will be readily understood by the skilled person.

In some embodiments, it is contemplated that the authentication request includes targeted advertisements, as discussed above. In these embodiments, it is contemplated that these targeted advertisements can come from a single advertiser and represent a plurality of possible products that could be targeted to the user, or alternatively, the targeted advertisement could come from a wide variety of advertisers and selected based on other information collected from the user, such as for example, purchasing habits, location, time of day, device type, screen type, connection speed, connection quality, software version and proximity to businesses, among other pieces of analytical information that will be readily appreciated by the skilled person.

For example, a targeted advertisement could relate to a series of financial products offered by a bank and could be displayed in an authentication request for access to the user's bank account, or alternatively the targeted ad could relate to a series of lunch deals offered to a mobile user in a particular neighbourhood and included in an authentication request when attempting to access a wi-fi network in a local coffee shop near lunch time.

It is also contemplated that in some embodiments the authentication request could include an advertisement that is a communication advertisement. In these embodiments it is contemplated that the communication advertisement can be any useful information that can be of interest to the user and can be of a commercial or non-commercial nature, such as for example, an instructional video, a public service warning about water quality at a local beach, or information regarding an upcoming company picnic. It is contemplated that these communications advertisements can be further targeted based on analytics previously collected from the user, and as such the advertisement can directly relate to the user who is attempting to access the resource.

In at least one embodiment, the authentication request can include a transcription or real time representation of the user describing the actual resource request. In this way the authenticator can compare the transcription or real time representation to the resource request to determine if there is any discrepancy between the two.

In at least one embodiment, it is contemplated that the predetermined roster of authenticators can be selected by the user, selected by an administrator, selected randomly from a group of previously qualified individuals, selected specifically based on pre-identified qualities of a group of previously qualified individuals, among other arrangements that will be readily understood by the skilled person. In some embodiments, the user is the authenticator.

In at least one embodiment, it is contemplated that the authenticator is selected from the predetermined roster of authenticators randomly, while in other embodiments it is contemplated that the authenticator is selected by the user, selected by an administrator, or selected based on pre-existing data that creates a factual connection to the user and the resource being accessed. For example, it is contemplated that in some embodiments, the authenticator will be selected because they work in the IT security department of a company, among other arrangements that will be readily understood by the skilled person.

In some embodiments, it is contemplated that the predetermined roster of authenticators is stored in a single database, or alternatively can be stored in a number of remote locations (such as a number of remote servers or alternatively the authenticators' devices) in order to make this information more difficult to uncover by a malicious third party.

It is contemplated that pre-existing data could include, but is not limited to, the user's behavioral patterns, the authenticator's job title, the authenticator's familial relationship to the user, the authenticator's availability, the authenticator's security clearance based on the resource, the authenticator's geographic location, the user's geographic location, the user's device identification, the authenticator's device identification, the authenticator's successful identification score, the user's trust score, among any other type of pre-existing data that could provide a factual connection between the user, authenticator and resource that the user is attempting to access.

In at least one embodiment, it is contemplated that an administrator could be a resource administrator, third party security administrator, network administrator, among any other type of administrator that would maintain and manage access to a resource as contemplated by the present invention and as will be contemplated by the skilled person.

It is contemplated that the authentication request may be sent to a single authenticator (such as for example, the user themselves or an authenticator selected by the user) or alternatively the authentication request may be sent to a plurality of authenticators. Further, in some embodiments, it is contemplated that multiple authentication requests are sent simultaneously to multiple authenticators simultaneously, while in other embodiments it is contemplated that additional authentication requests are sent to additional authenticators after an initial authentication request is authenticated by a first authenticator. In these latter embodiments, it is contemplated that two, three or more additional authentication requests are sent to additional authenticators after the initial authentication request is authenticated in an authentication response.

In at least one embodiment, it is contemplated that an authentication response could be, but is not limited to, an email response, an SMS response, an application-based response, a web-based response, phone calls, video calls, smartphone application notifications, software requests, software notifications, instant messaging notifications, instant messaging messages, presence system notifications, presence system alerts, presence system calls, presence system messages, VoIP messages, VoIP calls, VoIP video calls, social network message, social network alert and social network notifications, among any other suitable type of response that will readily be understood by the skilled person.

It is further contemplated that the authentication response could be included within the authentication request (and vice versa), or alternatively the authentication response could be separate from the authentication request.

In at least one embodiment, it is contemplated that an authenticator can validate the authentication response by confirming the identity of the user who is displayed in the real time representation that is included in the authentication request. The user's identity could be selected from a list that is provided to the authenticator or alternatively could be inputted into a text field or a button that is provided in the authentication response, among any other types of input interfaces that will be readily understood by the skilled person. It is also contemplated that the authenticator could verbally confirm the identification of the user when validating the authentication response, among other arrangements that will be readily understood by the skilled person.

In some embodiments, it is contemplated that the authenticator can access previously recorded instances where the user has successfully accessed a resource and can compare this to the current authentication request in order to validate or invalidate the authentication response.

In other embodiments, it is contemplated that the user is the authenticator and that the authentication response includes a positive or negative identification of an advertisement.

In embodiments where the authentication request is sent to a plurality of authenticators, it is contemplated in some of these embodiments that the authentication response will be validated by each of the authenticators in order to provide access to the resource and in other embodiments it will be contemplated that a predetermined number of the authenticators must validate the authentication response in order to provide access to the resource.

In at least one embodiment, it is contemplated that an authenticator can invalidate the authentication response by denying the identity of the user who is displayed in the real time representation that is included in the authentication request. Further, it is contemplated that the authentication response could be invalidated if the network connection between the authenticator and the user is lost, or alternatively, timed-out. It is contemplated that the authenticator can deny the identity of the user in a verbal manner by inputting appropriate data into the authentication response, among other arrangements that will be readily understood by the skilled person. In some embodiments, it is contemplated that the authenticator can review the review the authentication request after some delay if the particular situation is deemed high risk.

In embodiments where the authentication request is sent to a plurality of authenticators, it is contemplated in some of these embodiments that the authentication response will be invalidated by each of the authenticators in order to deny access to the resource and in other embodiments it will be contemplated that only one of the authenticators must invalidate the authentication response in order to deny access to the resource. In other embodiments, it will be contemplated that a predetermined number of authenticators must invalidate the authentication response in order to deny access to the resource.

It is contemplated that in some embodiments, once a user has been denied access to the resource an alert could be sent to a third party. It is contemplated that the third party could be the authenticator, a third party security service (such as an IT security firm or a law enforcement unit), or any other third party that will be readily understood by the skilled person.

It is contemplated that in some embodiments, once a user has been denied access to the resource, the session is logged, which could include recording the details of the user's access request and the authenticator's authentication response. In other embodiments, it is contemplated that when a user has been denied access to the resource, a pre-determined action is executed. In yet another embodiment, it is contemplated that the entire session is logged or recorded regardless of whether the user is provided or denied access to the resource as requested.

It is contemplated that in some embodiments, once an authenticator has validated the authentication request there will be at least one additional authentication request sent to the authenticator that includes an additional identification factor. In other embodiments, it is contemplated that the authentication request directly includes at least one additional identification factor.

It is contemplated that in some embodiments, once an authenticator has validated the authentication request there will be at least one additional authentication request sent to at least one additional authenticator. In these embodiments, it is contemplated that the additional authentication request includes a real time representation of the user.

In some embodiments, it is contemplated that the authentication request and the authentication response are sent by way of separate networks or communication channels, and in other embodiments it is contemplated that the authentication request and the authentication response are sent by way of the same network or communication channel, among other arrangements that will be readily appreciated by the skilled person. It is further contemplated that in some embodiments the authentication request and the authentication response can each be sent in part over separate networks or communication channels.

For example, it is contemplated that in some embodiments the authentication request can be sent in two parts across two separate communications networks/channels: a first audio element can be sent through a PSTN phone network to a telephone while a corresponding video element can be sent through any other data communications network to a laptop. In this way it is contemplated the authentication is sufficiently difficult to intercept and subvert by a malicious third party, and as such any attempt at interception would be readily detected and averted.

It is contemplated that the additional identification factor (also referred to herein as an identification factor) can include, but is not limited to, a unique device signature, an email address confirmation request, a username confirmation request, a date of birth confirmation request, a personal information confirmation request, a password request, a pin request, a pattern request, a USB token request, a algorithmic token based request, a smartcard request, a RFID chip request, a magnetic stripe card request, a software token request, a sms request, a smartphone push notification request, a mobile signature request, a mobile application request, a biometric data request, a device identification request, a phone call request, a user employee number, an authenticator user number, a password, a user's full name, an authenticator's full name, a user's social insurance number, an authenticator's social insurance number, a business number, a tax file number, a social security number, a bank account number, a credit card number, among any other type of additional identification factor that will be readily understood by the skilled person.

In some embodiments, it is contemplated that an additional identification factor is obtained from the user before the authentication request is sent to the authenticator. In this way, an initial layer of identification confirmation is provided prior to confirming the user's identity by sending the authentication request to the authenticator.

In these embodiments, once the user has requested access to a resource, an identification factor is obtained from the user. This provided identification factor is then compared to a database of predetermined identification factors to determine if the user has correctly provided the identification factor. If the user has properly provided the identification factor, an authentication request is sent to an authenticator and the method proceeds in an analogous manner as described above.

In some embodiments, the identification factor is a real time representation of the user that is compared to a database (or alternatively multiple databases, remotely or locally situated) of previously obtained user representations and subjected to an algorithmic analysis to generate a comparison score. Should the comparison score be below a predetermined threshold the identification factor may be rejected and the authentication response is not sent back to the user. Alternatively, the comparison score may be acceptable and the authentication response is accordingly sent to the user.

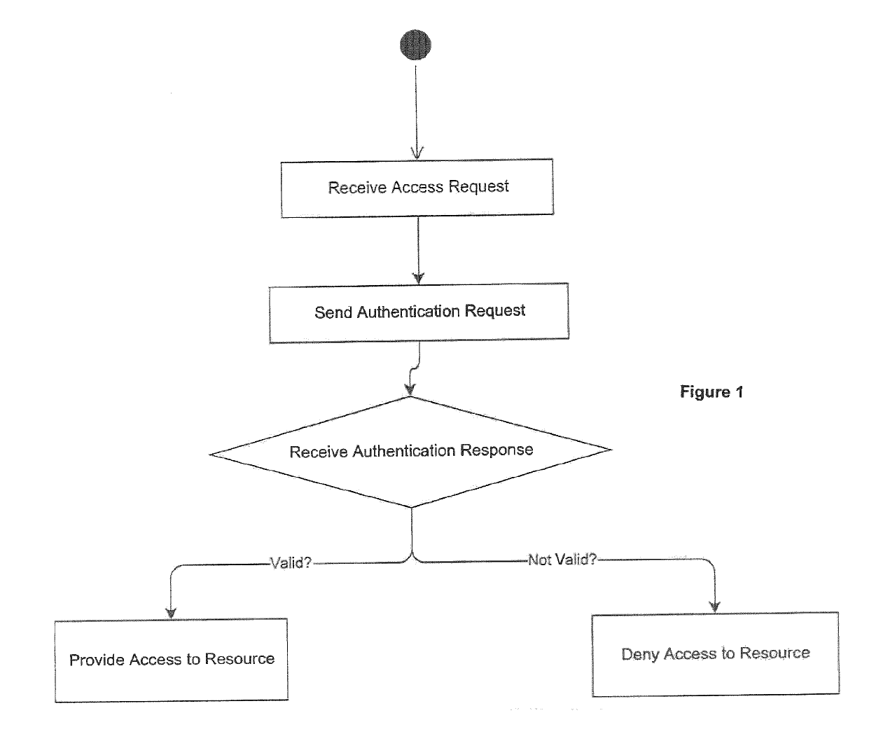

Turning to FIG. 1, at least one embodiment of the present invention is illustrated which is initiated when a user requests access to a resource through a network. In turn, an authentication request is sent through the network to an authenticator that is selected from a predetermined roster of authenticators. The authenticator must validate the authentication response or not validate the authentication response and send an authentication response through the network.

If the authentication response is validated by the authenticator, the user is provided access to the resource through the network. Alternatively, if the authentication response is not validated by the authenticator, the user is denied access to the resource through the network.

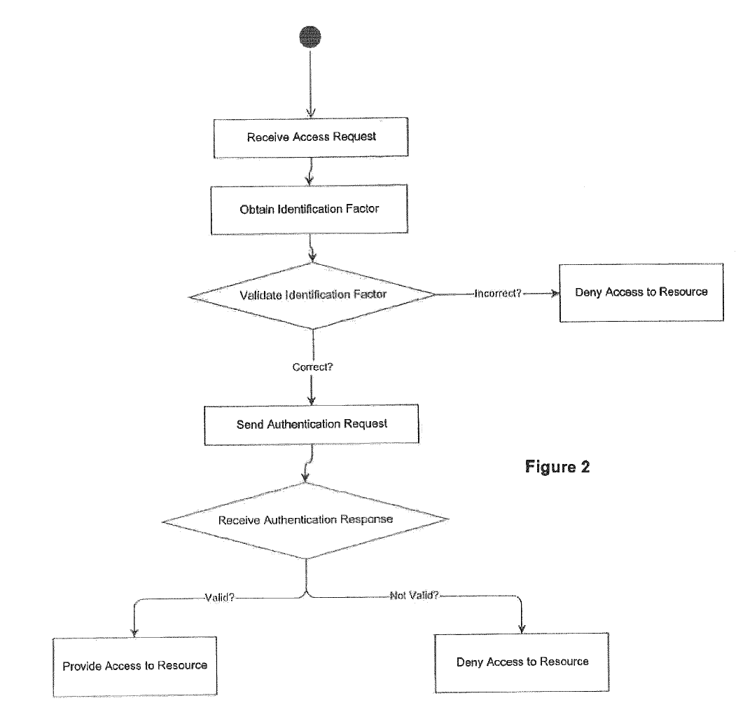

Turning now to FIG. 2, at least one embodiment of the present invention is illustrated which is initiated when a user requests access to a resource through a network. An identification factor is obtained from the user (such as, for example, a password) and this factor is compared against a database of previously determined identification factors that are stored in a database on the network and associated with the particular user. If the factor that is provided by the user is incorrect, the user can be denied access to the resource.

Alternatively, if the factor that is provided by the user is correct, an authentication request is sent through the network to an authenticator that can be selected from a predetermined roster of authenticators. In this embodiment, each authentication request includes a real time representation of the user. The authenticator must validate the authentication response or not validate the authentication response and send an authentication response which is received through the network.

If the authentication response is validated by the authenticator, the user is provided access to the resource through the network. Alternatively, if the authentication response is not validated by the authenticators, the user is denied access to the resource through the network.

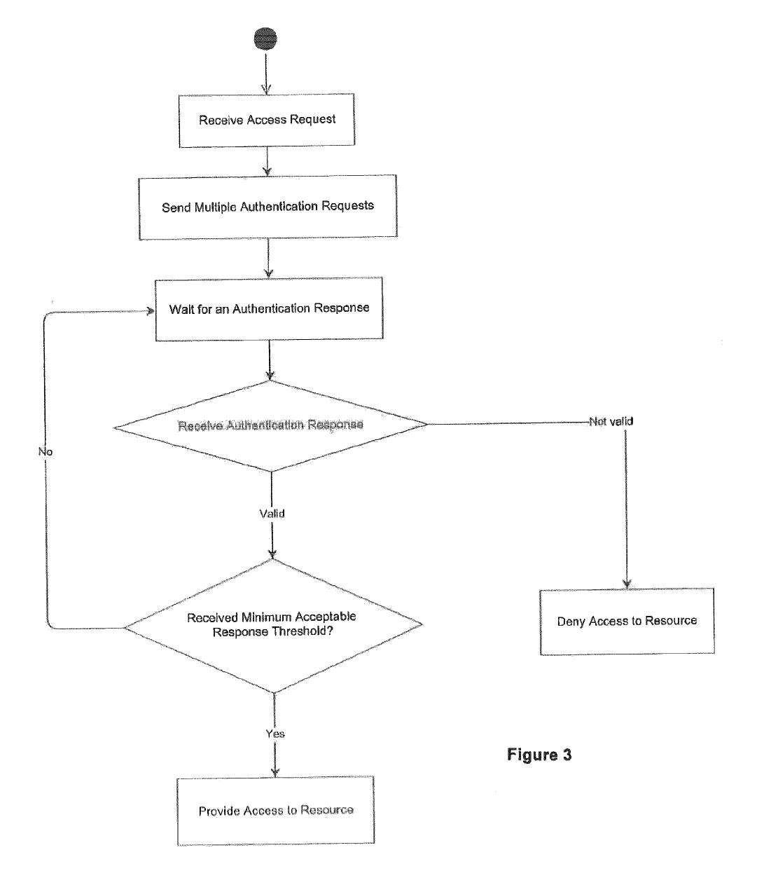

Turning now to FIG. 3, at least one embodiment of the present invention is illustrated which is initiated when a user requests access to a resource through a network. In turn, a plurality of authentication requests are sent through the network to a corresponding plurality of authenticators that can be selected from a predetermined roster of authenticators. In this embodiment, each authentication request includes a real time representation of the user. Each authenticator must validate the authentication response or not validate the authentication response and send an authentication response through the network.

If the authentication response is validated by all of the authenticators (or alternatively a predetermined number of authenticators), the user is provided access to the resource through the network. Alternatively, if the authentication response is not validated by all the authenticators (or a predetermined number of authenticators), the user is denied access to the resource through the network.

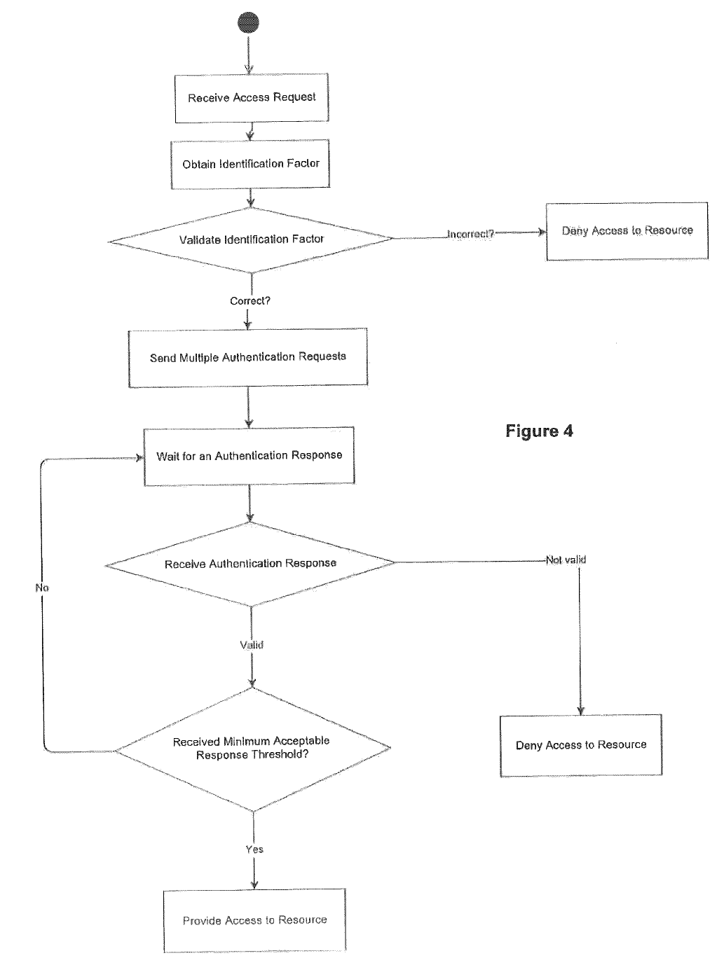

Turning now to FIG. 4, at least one embodiment of the present invention is illustrated which is initiated when a user requests access to a resource through a network. An identification factor is obtained from the user (such as, for example, a password) and this factor is compared against a database of previously determined identification factors that are stored in a database on the network and associated with the particular user. If the factor that is provided by the user is incorrect, the user can be denied access to the resource.

Alternatively, if the factor that is provided by the user is correct, an authentication request is sent through the network to a plurality of authenticators that can be selected from a predetermined roster of authenticators. In this embodiment, each authentication request includes a real time representation of the user. Each authenticator must validate the authentication response or not validate the authentication response and send an authentication response which is received through the network.

If the authentication response is validated by each of the authenticators (or alternatively, a predetermined number of the authenticators), the user is provided access to the resource through the network. Alternatively, if the authentication response is not validated by at least one of the authenticators (or alternatively, a predetermined number of authenticators or all the authenticators), the user is denied access to the resource through the network.

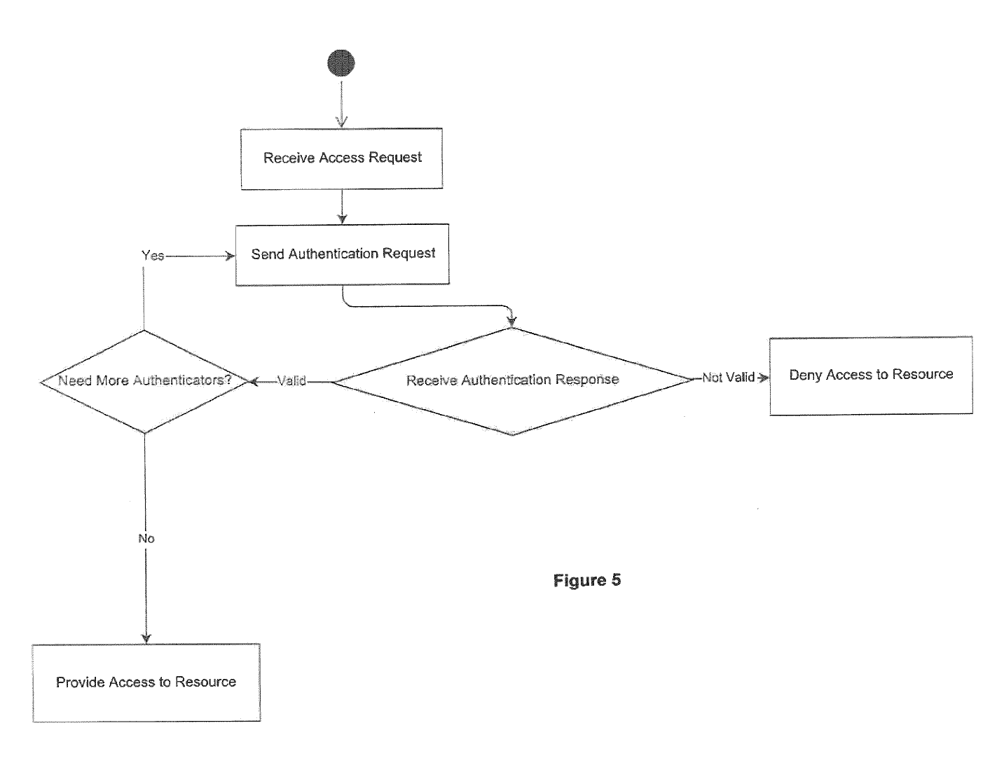

Turning now to FIG. 5, at least one embodiment of the present invention is illustrated which is initiated when a user requests access to a resource through a network. In turn, an authentication request is sent through the network to an authenticator that can be selected from a predetermined roster of authenticators. The authenticator must validate the authentication response or not validate the authentication response and send an authentication response through the network.

If the authentication response is not validated by the authenticator, the user is denied access to the resource through the network.

On the other hand, if the authentication response is validated by the authenticator, an additional authentication response is sent to an additional authenticator, who must validate the authentication response or not validate the authentication response and send an additional authentication response through the network. This process can be repeated until a predetermined number of authenticators have sent a corresponding number of validated authentication responses. Once the predetermined number of validated authentication responses is received, the user is provided access to the resource through the network.

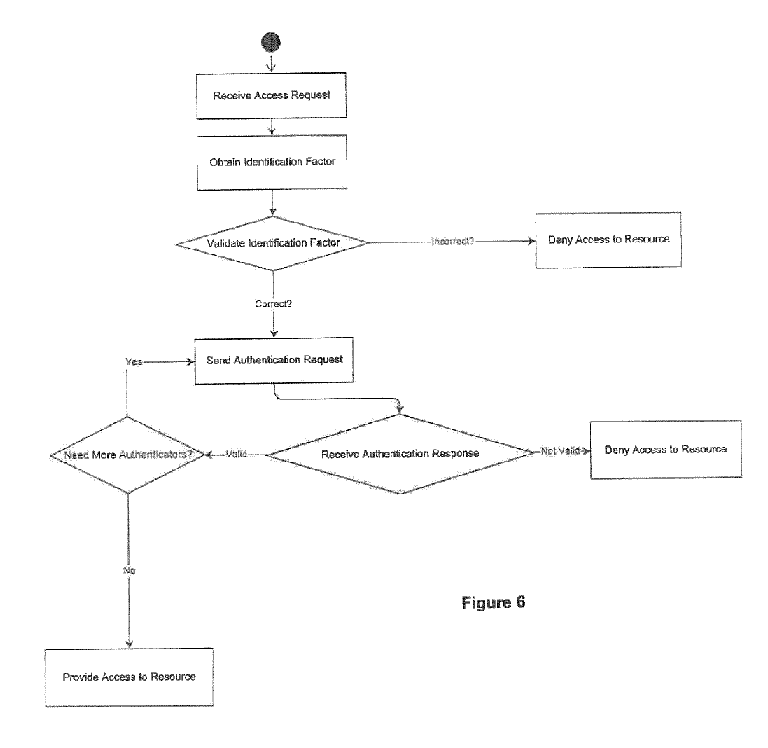

Turning now to FIG. 6, at least one embodiment of the present invention is illustrated which is initiated when a user requests access to a resource through a network. An identification factor is obtained from the user (such as, for example, a password) and this factor is compared against a database of previously determined identification factors that are stored in a database on the network and associated with the particular user. If the factor that is provided by the user is incorrect, the user can be denied access to the resource.

Alternatively, if the factor that is provided by the user is correct, an authentication request is sent through the network to an authenticator that can be selected from a predetermined roster of authenticators. In this embodiment, the authentication request includes a real time representation of the user. The authenticator must validate the authentication response or not validate the authentication response and send an authentication response through the network.

If the authentication response is not validated by the authenticator, the user is denied access to the resource through the network.

On the other hand, if the authentication response is validated by the authenticator, an additional authentication response is sent to an additional authenticator, who must validate the authentication response or not validate the authentication response and send an additional authentication response through the network. This process can be repeated until a predetermined number of authenticators have sent a corresponding number of validated authentication responses. Once the predetermined number of validated authentication responses is received, the user is provided access to the resource through the network.

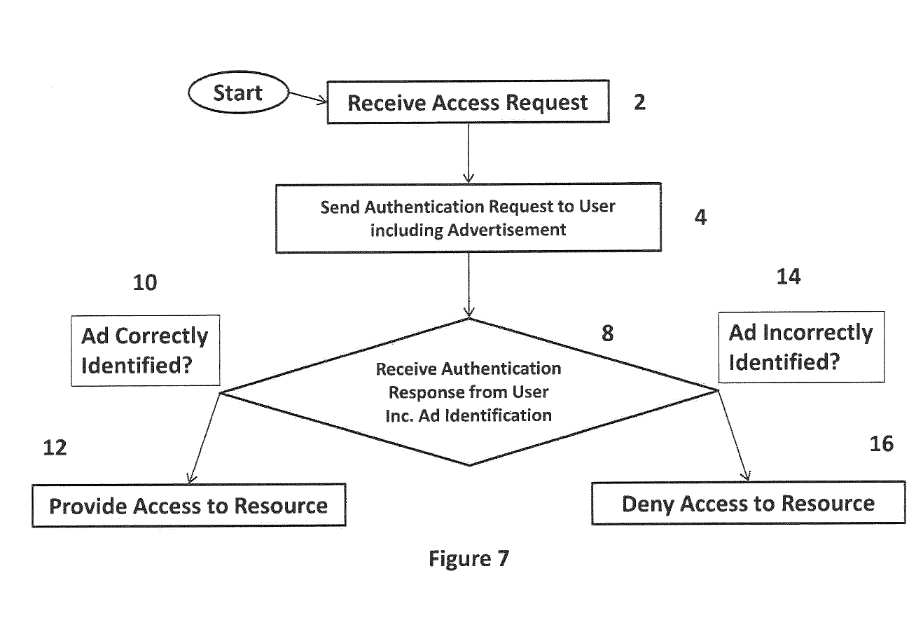

Turning to FIG. 7, at least one embodiment of the present invention is illustrated which is initiated when a user requests access to a resource through a network. In turn, an authentication request is sent (containing an advertisement) through the network to the authenticator who in this case is the user. The authenticator must validate the authentication response (by correctly identifying the advertisement) or not validate the authentication response (by incorrectly identifying the advertisement) and send an authentication response through the network.

If the authentication response is validated by the user/authenticator, the user is provided access to the resource through the network. Alternatively, if the authentication response is not validated by the user/authenticator, the user is denied access to the resource through the network.

The present invention will now be illustrated with the assistance of the following examples, which are intended to be illustrative embodiments.

### Example 1—User Accessing Personal Online Bank Account with Advertisement Identification

In at least one embodiment, a user wants to access an online bank account and as such submits a request to an online banking provider through a web site. An authentication request is sent through the network by SMS (or other data messaging protocol) to the user's mobile phone.

The user receives the SMS which contains the authentication request which opens up in the user's mobile phone with a third party video advertisement. The user is presented with three buttons labeled “Brand A”, “Brand B” and “Brand C” on the secure web page at the bottom of the video advertisement. The user (which in this embodiment is the authenticator) selects one of the buttons and sends the authentication response through the network.

If the user correctly selects the “Brand A” button to successfully validate the authentication request, the user is then provided access to the online bank account and can commence with the desired online banking services.

### Example 2—User Accessing Online Cloud File Storage Account with Advertisement Identification

In at least one embodiment, a user wants to access a cloud file storage account on their mobile phone and as such submits a request to access an online cloud file storage account through a mobile phone application. An authentication request is sent through the carrier channel mobile data network to the user's mobile phone, using an encrypted data system.

The user receives an encrypted data channel response in their application which contains the authentication request. A telephone call is then placed to the user on the same phone but using the publicly switched telephone network voice channel in which a series of two consecutive third party audio advertisements are played. The user is presented with an in application visual grid of twenty company logos, one of which correctly identifies the brand of the first audio advertisement being played. The user (which in this embodiment is the authenticator) selects one of the logos in the visual grid and thereby sends a first authentication response through the encrypted network.

If the authenticator selects a logo from the initial visual grid that does not match with the corresponding audio being played on the telephone voice channel, the user is then denied access to the cloud file storage system, the phone call is terminated, and the application is reset.

If the user correctly selects the logo which matches brand identified in the audio advertisement to successfully validate the initial authentication request, the second audio advertisement is then played on the telephone using the publicly switched telephone network voice channel. The user is presented with a second in-application visual grid of twenty company logos (which may or may not contain some of the same company logos), one of which correctly identifies the brand of the second audio advertisement being played. The user (which in this embodiment is the authenticator) selects one of the logos in the second visual grid and thereby sends a second authentication response through the encrypted network.

If the authenticator selects a logo from the second visual grid that does not match with the corresponding audio being played on the telephone voice channel, the user is then denied access to the cloud file storage system, the phone call is terminated, and the application is reset.

If the authenticator selects a logo from the second visual grid that does match with the corresponding audio being played on the telephone voice channel, the user's application is then connected with an encrypted data channel to the cloud file storage system and the user is provided access to their files and can commence with the desired remote file operations.

### Example 3—User Accessing Personal Online Bank Account

In at least one embodiment, a user wants to access an online bank account and as such submits a request to an online banking provider through a web site. An authentication request is sent through the network by SMS to two authenticators from a roster of predefined user determined authenticators, who are authenticators chosen by the user during the account set up process as people the user trusts to positively identify them. In this example, the authenticators might be the user's mother and a close friend of the user.

The authenticators receive the SMS which contains the authentication request and a secure webpage link, which opens up in the user's mobile phone with a real time video and audio session of the user. The authenticators are presented with three buttons labeled “Accept”, “Deny” and “Unsure” on the secure web page at the bottom of the live video and audio. Each authenticator selects one of the buttons and sends the authentication response through the network.

If both authenticators select the “Accept” button to successfully validate the authentication request, the user is then provided access to the online bank account and can commence with the desired online banking services.

### Example 4—User Accessing Personal Online Bank Account Through Identification of Targeted Advertisements

In at least one embodiment, a user wants to access an online bank account through a laptop and as such submits a request to an online banking provider through a web site. An authentication request is sent through the network by SMS to the user while the user progresses on the laptop to an interstitial webpage whereby the authentication response will be sent. In this embodiment the user is the authenticator.

The user receives the SMS which contains the authentication request which includes a secure webpage link, which opens up on the user's mobile phone with a targeted advertisement that has been selected based on the user's previous analytics. In this embodiment, the targeted advertisement relates to products offered by the bank that may be appealing to the user based on the user analytics previously collected by the bank.

On the interstitial webpage containing the authentication response and displayed on the laptop, the user is presented with 9 buttons relating to products offered by the bank. The user selects one of the buttons (which relates to the targeted advertisement delivered in the authentication request by SMS) and sends the authentication response through the network by way of the laptop.

If the user correctly identifies the targeted advertisement to validate the authentication request, the user is then provided access to the online bank account by way of the laptop and can commence with the desired online banking services.

### Example 5—User Accessing Local Wi-Fi Network Through Identification of Targeted Advertisements

In at least one embodiment, a user wants to access a free local Wi-Fi network and as such submits a request to the wi-fi network provider through a communication portal (such as a mobile device native software application) and displayed on the user's mobile phone. An authentication request is sent through the network through the communication portal to the user's mobile phone.

The user receives the authentication request which opens up in the user's mobile phone with a targeted video advertisement relating to offers selected based on the user's location to a number of restaurants in the immediate geographic area and the time of day. The user is presented with four buttons labeled “Deal A”, “Deal B”, “Deal C” and Deal “D” on a secure web page that is displayed following the video advertisement. The user (which in this embodiment is the authenticator) selects one of the buttons and sends the authentication response through the network.

If the user correctly selects the “Deal A” button to successfully validate the authentication request, the user then receives a second authentication request which opens up in the user's mobile phone with a second targeted audio advertisement relating to offers selected based on the user's location to a number of hotels in the immediate geographic area. The user is presented with three buttons labeled “Deal A”, “Deal B” and “Deal C” on a secure web page that is displayed following the second video advertisement. The user (which in this embodiment is the authenticator) selects one of the buttons and sends a second authentication response through the network.

If the user correctly selects the “Deal B” button to successfully validate the second authentication request, the user provided access to the wi-fi network and can commence with the desired online services.

### Example 6—User Initiated Password Reset

In at least one embodiment, a user wants to reset a password to access their corporate user account and work laptop. In order to initiate the password reset request, the user submits a request through the network by way of their mobile phone or through the login screen of their corporate laptop. Information regarding the user's corporate username is obtained from the user in a text input box that is provided in the user interface of the password reset request.

Once the user has provided their corporate username as a primary identification factor, it is compared against a database of usernames that is stored on the network to confirm it is valid. This database of valid usernames was populated with user-specific identification when the user first joined the company.

Once the username has been confirmed, an authentication request is sent to a series of authenticators that have previously been selected by an administrator from the company's IT department. In this example, the authentication request is an application notification that pops up on the authenticator's smartphone. Once the authenticator opens the application they are presented with a real time video and audio display of the user. The user has a live audio link to the authenticator, but may or may not have a live video link to the authenticator.

Once the authenticator positively acknowledges the user, the authenticator will then positively authenticate the user, by using a button on the user interface of the mobile phone application. Once the user has been accepted by the minimum amount of authenticators the user's open session in the mobile application will present him with the reset corporate password and the user will be able to login using this temporary password.

### Example 7—Remote Deletion of Data

In at least one embodiment, a user wants to remotely delete online data that is stored in a network database. In order to delete the stored data, the user makes a request through a network to delete the stored data and a first authentication request is sent to a first authenticator that is a notification on desktop software installed on the authenticator's desktop or laptop computer. Once the notification is clicked and disclaimer accepted, an application opens with live video and audio of the user. Once the first authenticator provides a positive authentication response by clicking a button at the bottom of the application accepting the user's identity, a second authentication request is sent to a second authenticator. After the second authenticator authenticates the second authentication response by clicking a button at the bottom of the application accepting the user's identity the user's request is approved and the user can now delete the online data.

### Example 8—Remote Secure Wipe of Device

In at least one embodiment, a user wants to remotely delete all data stored locally on a device such as a laptop computer or mobile phone. In order to securely delete the data on the device, the user makes a request through a network and a first authentication request is sent to a first authenticator through a mobile phone application that contains an embedded link to initiate a live two way video call between the user and the authenticator. Once the first authenticator provides a positive authentication response by clicking a button included within the first authentication request (which is simultaneously displayed during the video call between the user and the authenticator), a second authentication request is sent to a second authenticator. After the second authenticator provides a positive authentication response, the user's request is approved and the remote device is completely wiped clean of all data using a multi pass secure deletion process.

### Example 9—Remote Reboot of Resource

In at least one embodiment, a user wants to remotely reboot a remotely located network server. In order to remotely reboot the network server, the user makes a request through a network to reboot the network server and an identification factor is obtained from the user. Once the identification factor is checked against a database of predetermined identification factors for that particular user, an authentication request is sent through the network to five authenticators that are chosen from a roster of authenticators. Each authentication request is a SMS message that includes a link to a webpage that displays live video and audio of the user. If four of the authenticators provide positive identification of the user by clicking on a positive identification button, then the user is provided access to the network server in order to reboot it.

### Example 10—Approval of Transfer of Funds Through Online Banking

In at least one embodiment, a user wants to access an online bank account that they are legitimately authorized to conduct transactions from to enable them to transfer funds to a third party. In order to gain access to the online bank account to initiate a money transfer, the user makes a request to access the bank account, which is then granted through the use of a predetermined username and password and a second factor of identification of some description (for example, a possession factor such as a secure time based token, or secondary knowledge based factors set up in advance by the user) as is currently commonly practiced and widely covered by prior art. The user then requests to transfer money to a third party. An authentication request is then sent through the network to a randomly selected authenticator from a predetermined roster of authenticators, all of whom know the user personally. The authentication request is initiated by an automated telephone call that includes a request to initiate a live video and audio display of the user via a mobile phone application. The authenticator logs into the mobile phone application and after the real time two way video session between the user and the authenticator is complete, the authenticator sends an authentication response through the network that includes a verbal confirmation of the user's identity. For accountability purposes and bank anti-fraud purposes, every such authentication video is recorded and logged. If the authenticator provides a negative authentication response, the bank's security department is immediately notified, and the user's access to the account is immediately terminated. If the authenticator provides a non-positive authentication response, another authenticator process may be initiated with alternative authenticator randomly selected from the aforementioned predetermined roster of authenticators. If more than one non-positive response is registered in a defined period of time, the user may have to physically go to the bank in person to complete the transaction. If the authenticator provides a positive authentication response is received through the network, the user's transfer of funds request is initiated and a wire transfer or other monetary transfer method is enacted, sending the funds to the third party.

### Example 11—Access to Flow Control Valve

In at least one embodiment, a user wants to obtain access to a remotely located flow control valve, such as a shut off valve in a natural gas pipeline network, or a flow control valve within a sewage network. In order to gain access to the control valve, the user sends an access request through a network. A series of three authentication requests are sent to a series of three authenticators that are specifically identified as having an appropriate level of decision making responsibility with respect to the flow control valve. Each authentication request is sent through a secure website and includes a live video link. Once an authentication response is received from each authenticator, each authenticator provides an additional identification factor that confirms the identity of the authenticator. If each identification factor is identified as correct with respect to a predetermined database of identification factors relating to the authenticators that is stored on the network, and all authenticators provide a positive response to the users request, the user is provided remote access to the flow control valve, allowing them to change the state of the valve, thereby opening, closing or changing the flow rate through the valve without having to be physically present at the site.

### Example 12—Access and Remote Control of Assets

In at least one embodiment, the user desires to take control of a remotely located asset, such as an unmanned aerial vehicle (UAV), driverless car or earth observation satellite. In order to gain access to the asset, the user sends a secure access request through a network. An authentication request is then sent to a specifically selected access granting authenticator who has an appropriately high level of security clearance. The authentication request is an encrypted instant message containing an embedded real time video of the user, which contains audio. The authenticator interacts with the user, asking predetermined code word based challenge response questions as a second level of authentication, and once satisfied provides a positive authentication response by clicking on a button marked “Approved for Access” embedded within the encrypted instant message system. The recorded live video session between the first authenticator and the user is sent to an operations center for video analysis and review. Once the first authentication response is received through the network, a second authentication request is sent to a second authenticator with a more senior security clearance level to provide approval for control of the asset. The second authenticator provides a positive authentication response by clicking on a button marked “Approved for Control” embedded within the encrypted instant message system. If a second positive authentication response is sent through the network by the second authenticator, the user is then provided with remote control of the asset. If at any time, the operations center staff suspects there may be reason to believe that the user is under undue stress or is not suitable to take control of the asset, access and control rights may be withdrawn.

### Example 13—Access Company Balance Sheet

In at least one embodiment, a user of a wearable computing device requests access to sensitive company information such as a balance sheet. The user requests access to the balance sheet by speaking a command into their wearable computing device such as Google®'s Glass. The Google® Glass unit tries to access the company information but receives an error saying that to view the information requires further verification. The Google® Glass unit then sends an authentication request through a network to all authenticators on the roster of predetermined authenticators for that resource. Authenticators from the roster of predetermined authenticators are then notified on their own wearable computing devices such as Google® Glass using the heads up display notification and an audible message on their headset. The first authenticator to accept the heads up display notification starts the authentication session with the user. Once the first authenticator accepts the notification a real time video and audio session using the Google® Glass unit's facial positioned camera and microphone are started. After verifying the user and their appropriate clearance for the requested balance sheet, the authenticator speaks a verbal command into the wearable computing device that grants access for the user to the balance sheet.

### Example 14—User Accessing Personal Online Bank Account with Verbal Transcription of Access Request

In at least one embodiment, a user wants to access an online bank account to make a deposit and as such submits a request to an online banking provider through a web site. An authentication request is sent through the network by SMS to an authenticators from a roster of predefined user determined authenticators, who are authenticators chosen by the bank during the account set up process as people who have the requisite level of security to oversee such transactions. In this example, the authenticator might be a bank's IT specialist.

The authenticator receives the SMS which contains the authentication request and a secure webpage link, which opens up in the authenticator's mobile phone with an audio transcription of the user describing that they are “John Doe attempting to make a deposit to my savings account”.

The authenticator is presented with three buttons labeled “Accept”, “Deny” and “Unsure” on the secure web page at the bottom of the live video and audio. The authenticator reviews the initial access request in view of the transcription and selects one of the buttons and sends the authentication response through the network.

If the authenticator selects the “Accept” button to successfully validate the authentication request, the user is then provided access to the online bank account to make the deposit and can commence with the desired online banking services.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A method for authenticating user access to a resource, the method comprising the steps of:
receiving an access request from a user to access a resource;
sending at least one authentication request to at least one authenticator;
receiving an authentication response from said at least one authenticator;
providing access to said resource if said authentication response is validated by at least one of said at least one authenticator; and
denying access to said resource if said authentication response is not validated by at least one of said at least one authenticator.

2. The method of claim 1 wherein the authenticator is selected from a predetermined roster of authenticators.

3. The method of claim 1, wherein the at least one authentication request includes a real time representation of the user.

4. The method of claim 1, wherein said resource is selected from the group consisting of digital data, digital storage, a software application, a computer system, a user account, a virtual private network, networking equipment, load balancers, routers, switches, storage area networks, network attached storage, KVM (keyboard, video and mouse) access, servers, modems, wireless repeaters, remote desktops, virtual machines, hypervisors, device profiles, identity management platform access and identity management platform profiles.

5. The method of any claim 3, wherein said real time representation of said user is a video of said user or said real time representation of said user includes video of said user and audio of said user.

6. (canceled)

7. The method of claim 1, wherein said authentication response is validated and includes positive verification of the identification of said user by each said at least one authenticator.

8. The method of claim 1, wherein said authentication response is not validated and includes a negative verification of the identification of said user by at least one of said at least one authenticator.

9. The method of claim 1, wherein said authentication response is not validated and generated after a predetermined period of time has elapsed without receiving an authentication response from at least one of said at least one authenticator.

10. The method of claim 1, wherein said authentication response includes a non-positive verification of the identification of said user by at least one of said at least one authenticator.

11. (canceled)

12. The method of claim 2, wherein said roster of authenticators is predetermined by an administrator or said roster of authenticators is predetermined based on pre-existing data.

13. (canceled)

14. The method of claim 12, wherein said pre-existing data is selected from the group consisting of the user's behavioral patterns, the authenticator's job title, the authenticator's familial relationship to the user, the authenticator's availability, the authenticator's security clearance based on the resource, the authenticator's geographic location, the user's geographic location, the user's device identification, the authenticator's device identification, the authenticator's successful identification score and the user's trust score.

15. The method of claim 1, wherein said access request is a password reset request and providing access to said resource comprises resetting a password associated with said user.

16. The method of claim 1, further comprising the step of sending at least one additional authentication request to at least one additional authenticator selected from said predetermined roster of authenticators if said authentication response is validated, and providing access to said resource if at least one of said at least one additional authentication response is validated by at least one of each said at least one additional authenticator.

17. The method of claim 1, wherein said at least one authentication request further includes at least one additional identification factor.

18. The method of claim 17, wherein said at least one additional identification factor is selected from the group consisting of a unique device signature, an email address confirmation request, a username confirmation request, a date of birth confirmation request, a personal information confirmation request, a password request, a pin request, a pattern request, a USB token request, a algorithmic token based request, a smartcard request, a RFID chip request, a magnetic stripe card request, a software token request, an sms request, a smartphone push notification request, a mobile signature request, a mobile application request, a biometric data request, a device identification request and a phone call request.

19. The method of claim 1, wherein the step of denying access to said resource if said authentication response is not validated by each said at least one authenticator further comprises at least one of: sending an alert to a pre-determined third party, executing a pre-determined action and recording a session log.

20. The method of claim 1, wherein said at least one authenticator is selected from said roster of authenticators by an administrator or said at least one authenticator is selected from said roster of authenticators by said user or said at least one authenticator is randomly selected from said roster of authenticators or said at least one authenticator is selected from said roster of authenticators based on said resource.

21-23. (canceled)

24. The method of claim 2, wherein said authenticator is selected from said roster of authenticators based on a factor selected from the group consisting of: the user's behavioral patterns, the authenticator's job title, the authenticator's familial relationship to the user, the authenticator's availability, the authenticator's security clearance based on the resource, the authenticator's geographic location, the user's geographic location, the user's device identification, the authenticator's device identification, the authenticator's successful identification score and the user's trust score.

25. The method of claim 1, wherein said at least one authentication request includes an advertisement and said authenticator is the user.

26. (canceled)

27. The method of claim 25 wherein the advertisement is selected from the group consisting of: a video advertisement, an audio advertisement, an interactive advertisement, a targeted advertisement, a communication advertisement and a visual advertisement.

28. The method of claim 25, wherein said authentication response is validated and includes positive verification of the advertisement by said user.

29. The method of claim 25, wherein said authentication response is not validated and includes a negative verification of the advertisement by said user.

30. The method of claim 25, wherein said authentication response is not validated and generated after a predetermined period of time has elapsed without receiving an authentication response from said user.

31. The method of claim 25, wherein said invalidated authentication response includes a non-positive verification of the advertisement by said user.

32. The method of claim 25, wherein said access request is a password reset request and providing access to said resource comprises resetting a password associated with said user.

33. The method of claim 25, further comprising the steps of:
sending at least one additional authentication request to at least one additional authenticator selected from said predetermined roster of authenticators if said authentication response is validated, said at least one additional authentication request including a real time representation of said user, and
providing access to said resource if at least one of said at least one additional authentication response is validated by at least one of each said at least one additional authenticator.

34. The method of claim 25, wherein said at least one authentication request further includes at least one additional identification factor.

35. The method of claim 34, wherein said at least one additional identification factor is selected from the group consisting of a unique device signature, an email address confirmation request, a username confirmation request, a date of birth confirmation request, a personal information confirmation request, a password request, a pin request, a pattern request, a USB token request, a algorithmic token based request, a smartcard request, a RFID chip request, a magnetic stripe card request, a software token request, an sms request, a smartphone push notification request, a mobile signature request, a mobile application request, a biometric data request, a device identification request and a phone call request.

36. The method of claim 25, wherein the step of denying access to said resource if said authentication response is not validated further comprises at least one of: sending an alert to a pre-determined third party, executing a pre-determined action and recording a session log.

37. The method of claim 33, wherein said at least one additional authenticator is selected from said roster of authenticators by an administrator or said at least one additional authenticator is selected from said roster of authenticators by said user or said at least one additional authenticator is randomly selected from said roster of authenticators or said at least one additional authenticator is selected from said roster of authenticators based on said resource.

38-40. (canceled)

41. The method of claim 33, wherein said additional authenticator is selected based on a factor selected from the group consisting of: the user's behavioral patterns, the authenticator's job title, the authenticator's familial relationship to the user, the authenticator's availability, the authenticator's security clearance based on the resource, the authenticator's geographic location, the user's geographic location, the user's device identification, the authenticator's device identification, the authenticator's successful identification score and the user's trust score.

42. A method for authenticating user access to a resource, the method comprising the steps of:
receiving an access request from a user to access a resource;
obtaining an identification factor from said user;
receiving said identification factor from said user;
comparing said identification factor against a database of predetermined identification factors associated with said user to determine if said identification factor is correct;
denying access to said resource if said identification factor is not correct;
sending at least one authentication request to at least one authenticator if said identification factor is correct,
receiving an authentication response from said at least one authenticator;
providing access to said resource if said authentication response is validated by at least one of said at least one predetermined third party; and
denying access to said resource if said authentication response is not validated by at least one of said at least one predetermined third party.

43-47. (canceled)

48. The method of claim 42, wherein said authentication response is validated and includes positive verification of the identification of said user by each said at least one authenticator.

49. The method of claim 42, wherein said authentication response is not validated and includes a negative verification of the identification of said user by at least one of said at least one authenticator.

50. The method of claim 42, wherein said authentication response is not validated and generated after a predetermined period of time has elapsed without receiving an authentication response from at least one of said at least one authenticator.

51. The method of claim 42, wherein said authentication response includes a non-positive verification of the identification of said user by at least one of at least one authenticator.

52-56. (canceled)

57. The method of claim 42, further comprising the step of sending at least one additional authentication request to at least one additional authenticator selected from said predetermined roster of authenticators if said authentication response is validated, and providing access to said resource if at least one of said at least one additional authentication response is validated by at least one of each said at least one additional authenticator.

58-77. (canceled)

78. A system for authenticating user access to a resource, the system comprising:
communication means for receiving an access request from a user to access a resource;
communication, storage and imaging means for sending at least one authentication request to at least one authenticator;
communication means receiving an authentication response from said at least one authenticator;
communication means for providing access to said resource if said authentication response is validated by at least one of said at least one authenticator; and
communication means for denying access to said resource if said authentication response is not validated by at least one of said at least one authenticator.

79. A system for authenticating user access to a resource, the system comprising:
communication means for receiving an access request from a user to access a resource;
communication means for an identification factor from said user;
communication means for receiving said identification factor from said user;
communication, storage and comparison means for comparing said identification factor against a database of predetermined identification factors associated with said user to determine if said identification factor is correct;
communication means for denying access to said resource if said identification factor is not correct;
communication and imaging means for sending at least one authentication request to at least one authenticator if said identification factor is correct,
communication means for receiving an authentication response from said at least one authenticator;
communication means for providing access to said resource if said authentication response is validated by at least one of said at least one predetermined third party; and
communication means for denying access to said resource if said authentication response is not validated by at least one of said at least one predetermined third party.
